(19) United States
(12) Patent Application Publication
(10) Pub. No.: US 2011/0146260 A1
(43) Pub. Date: Jun. 23, 2011

(54) HYDRAULIC SYSTEM HAVING A HYDROSTATIC, VALVE-CONTROLLED PISTON ENGINE

(76) Inventors: Alejandro LOPEZ PAMPLONA, Horb (DE); Bjoern Beuter, Hirrlingen (DE)

(21) Appl. No.: 12/959,004

(22) Filed: Dec. 2, 2010

(30) Foreign Application Priority Data
Dec. 3, 2009 (DE) 10 2009 056 776.3

(51) Int. Cl. F16D 31/02

(52) U.S. Cl. 60/459

(57) ABSTRACT

The invention relates to a hydraulic system, having a hydrostatic, valve-controlled piston engine with a plurality of valves actuatable by an actuator as a function of the motion of the pistons, and with a control unit for triggering the actuators, which is arranged for generating an electrical attraction current in a first time segment and a maintenance current in a second time segment. The object of the invention is for the valves to switch with quick reactions and function safely, so that the expected functionality and safe operation of the hydrostatic piston engine under various operating conditions is ensured. This is attained in that the control unit includes a current regulating device, which triggers the actuators in current-regulated fashion.

### CROSS-REFERENCE TO RELATED APPLICATION

This application is based on German Patent Application 10 2009 056 776.3 filed on Dec. 3, 2009.

### BACKGROUND OF THE INVENTION

1. Field of the Invention

The invention is based on a hydraulic system.

2. Description of the Prior Art

Such hydraulic systems have a hydrostatic piston engine, whose volume flow is continuously variably adjustable via a valve controller. The hydrostatic piston engine is a plurality of pistons, movable back and forth periodically in cylinders, each piston defining one work chamber whose volume varies with the stroke of a piston and which can be made to communicate with a low-pressure connection via a low-pressure valve and with a high-pressure connection via a high-pressure valve. At least the low-pressure valves are actuated by means of an actuator, which in turn is triggered by a control unit. The valves must be capable of being switched highly dynamically, so that the work chamber can be very quickly blocked off or opened for a flow through it. To enable activating these valves as fast as possible, it is necessary upon actuation to have the largest possible attraction current flow through the actuator. The high actuation current produces a magnetic force in the actuator that is proportional to the current and that can mechanically actuate the valve. The high attraction current, however, leads to a corresponding power loss in the ohmic resistor of the actuator, which can heat the valve severely and impermissibly if triggering lasts a relatively long time. For maintaining the switching position of the valve, all that is needed in addition is a comparatively low maintenance current. Typically, the triggering of the valves is effected by means of a change in the voltage that is applied at the valve. A voltage change profile is specified in the control unit by software-based pilot control, and the pilot control in turn is based on experimentally ascertained data. Thus the voltage change profile includes an activation voltage profile for the attraction phase of the actuators as well as a reduced maintenance voltage profile for the maintenance phase.

The attraction current resulting from the activation voltage, and the maintenance current that varies with the temperature of the valve, can assume high values in an uncontrolled way. High current levels, or overswings in the current course, among other effects cause damage to electronic components or cable connections, for instance from overloading or thermal overheating. Moreover, imprecisions arise in the switching times of the valves, which depend strongly on the operating conditions at the time. That in turn is critical for the safety and sturdiness of the system

### OBJECT AND SUMMARY OF THE INVENTION

It is the object of the invention to further develop a hydraulic system such that the valves switch with fast reactions and functionally safely, so that the expected functionality and safe operation of the hydrostatic piston engine is ensured under various operating conditions.

In the hydraulic system of the invention, the control unit includes a current regulating device, which triggers the actuators in current-regulated fashion.

By means of the apparatus according to the invention, the advantage is obtained that the actuator current is regulated, and thus from the detection of the actuator current course, the exact switching time is ascertained, and thus fast reaction times of the valve can be attained.

For perfect function of a valve-controlled hydrostatic piston engine, it is essential that errors such as short circuits, line interruptions, and overloading or overheating, be detectable reliably and quickly. Sources of error are quickly detected by read-out of the actuator current for a higher-order plausibility check with either the model value or the expected value, and permit fast counter-control for safe, sturdy operation.

By limiting the actuator current to a maximum value, it is unnecessary to design a control unit for higher currents, which leads to a cost saving. A regulated current also lead to correspondingly less lost heat, so that the components and possibly still other component groups combined in a housing are subject to less temperature stress.

Advantageously, the current-regulated triggering of the actuator is effected in the second time segment during the maintenance phase. In the actuated state of the valve, the maintenance current for maintaining the switching position is relatively slight. A relatively small regulated current also leads to correspondingly less thermal power loss. Reducing the power loss leads to structural compactness of the control unit. Regulating the actuator current can also be done during the first time segment or in both time segments. By precise monitoring of the current, both excessively high current levels and overswings in the current course are avoided. As a result of the regulation of the current course, the operation of the valve-controlled hydrostatic piston engine functions exactly as a result of the precise ascertainment of the switching points as a function of the current course, as well as safely, since overly high current levels and overswings in the current course are avoided.

In an especially preferred feature of the present invention, the current-regulated triggering of the actuator is effected by means of a clocked trigger voltage output by the control unit. This means that the attraction and/or maintenance voltage is varied in its effective voltage value by pulse width modulation. This has the advantage that the effective voltage value, based on a basic voltage such as the battery voltage, can be adjusted solely by pulse width modulation. Instead of the direct output of the clocked trigger voltage, the control unit can send an ON or OFF signal via a communications interface, and downstream electronic components convert these control commands into digital or PWM signals.

In an advantageous embodiment of the apparatus of the invention, for simple measurement of the actuator current, the current regulating device has a measuring resistor or shunt downstream of the actuator. The shunt is a low-impedance resistor, whose detected voltage drop furnishes the actual current value of the actuator.

Moreover, the current regulating device has a differential amplifier, which detects the voltage drop applied via the measuring resistor and furnishes a differential amplifier voltage which corresponds to the actual current value of the actuator.

Preferably, the current regulating device includes a current regulator, connected downstream of the differential amplifier, that compares the output signal of the differential amplifier, as an actual current value, with a set-point current value and controls the voltage supply to the actuator as a function of the differential current. An alternative to this purely electronic hardware version is a microprocessor with software stored in it for read-in of the actual current value, comparing it with the set-point value, and controlling or regulating the actuator current by evaluation of the differential current.

In an especially preferred feature of the present invention, the current regulating device has first switching elements and a pulse width modulator for triggering the switching elements. Current regulation can be attained economically, without software regulation, by means of minimum and maximum current regulation thresholds via a current regulator output signal, in that first switching elements are triggered via pulse counter modulation, as a function of the different current thresholds.

The PWM output signal of the current regulator can be carried to these switching elements, which for instance are field effect transistors.

If the current regulating device is implemented as an integrated circuit, further improvements are obtained with regard to diagnostic capabilities. In addition, the space required for the electronic components is reduced, and the thermal management is improved.

It may be advantageous to accomplish the communication within the overall control unit via a bus system. As a result, additional economies of space and error-free data transmission can be achieved.

Preferably, the control unit includes a voltage-increasing device, which generates a higher voltage from an operating voltage of the control unit, and that is supplied to the control unit. As a result, the attraction phase of the actuator can be shortened considerably.

In an advantageous feature of the apparatus of the invention, the voltage-increasing device has a boosting circuit, which particularly in response to a corresponding trigger signal charges a buffer memory to a higher voltage. The boosting circuit proves advantageous because in that case only one voltage source, the operating voltage, is required. Since the increased voltage is available only for at least the duration of the attraction phase, the energy consumption of the boosting circuit is quite low. Moreover, the buffer memory version is simple and favorable to implement.

Preferably, the buffer memory is switched to the actuator by second switching elements during the attraction phase. As a result, the increased voltage is switched to the actuator only for the duration of the attraction phase.

If the current regulating device, for regulating the current of the actuator, triggers the second switching elements during the attraction phase, then the actuator current can be regulated during the attraction phase as well.

Because the current regulating device, for regulating the current of the actuator, can trigger the first switching elements during the maintenance phase, the actuator current can be regulated during the maintenance phase as well.

The invention is not limited to a purely electronic hardware version. In general, the implementation or representation of the current regulation is dependent on the particular application. If inexpensive versions are of primary importance, if the demands from the outset are virtually static, and if hardware components without relatively expensive microprocessors and software are already available, then the purely hardware version is certainly to be preferred. However, if the demands are dynamic and have to be expandable, then implementation becomes more expensive, and possibly other or additional components (such as microprocessors and software) must be employed.

### BRIEF DESCRIPTION OF THE DRAWINGS

The invention will be better understood and further objects and advantages thereof will become more apparent from the ensuing detailed description of a preferred embodiment taken in conjunction with the drawings, in which:

FIG. 1 is a highly schematic illustration to explain the functional principle of a valve-controlled hydrostatic piston engine with a variable volume flow; and

FIG. 2 is a schematic circuit diagram of one embodiment of the current regulating device of the invention in a control unit.

### DESCRIPTION OF THE PREFERRED EMBODIMENT

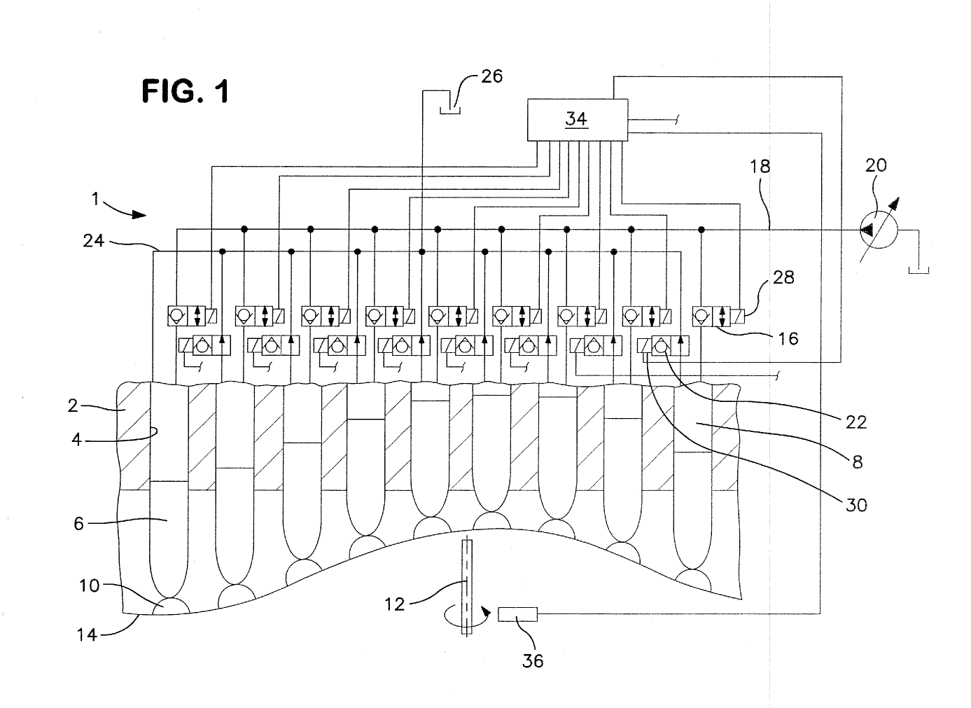

First, the functional principle of a valve-controlled piston engine 1, whose displacement/absorption volume is digitally adjustable (DDU), will be explained in conjunction with FIG. 1. The piston engine described, in the exemplary embodiment shown, is embodied as an axial piston engine 1 of the swash plate type, and FIG. 1 shows a very highly simplified developed view of it. In the ensuing description, the piston engine 1 is described as a hydromotor; however, in principle the descriptions of the hydromotor pertain accordingly to a pump with an adjustable displacement volume.

In the schematic view in FIG. 1, the piston engine 1 has a cylinder drum 2, in which a plurality of cylinder bores 4 are embodied, in each of which one piston 6 is guided axially displaceably. Each of the pistons 6, with the cylinder bore 4, defines a work chamber 8 whose volume is independent of the stroke of the pistons 6. These pistons are each braced via a respective piston shoe 10 on an obliquely positioned swash plate that is connected to a power takeoff shaft 12. In the view in FIG. 1, the control curve 14 formed because of the rotation of the swash plate is shown, which reflects the dependency of the piston stroke and thus of the volume of the particular work chamber on the angle of rotation. As shown on the right in FIG. 1, each work chamber 8 communicates via an inlet valve 16 with an inlet line 18 common to all the work chambers 8, and that line is subjected to system pressure or high pressure. This high pressure can be generated for instance via a pump 20.

Each work chamber 8 furthermore communicates via an outlet valve 22 with an outlet line 24, likewise common to all the work chambers 8, which discharges into a tank 26.

In the exemplary embodiment shown, the outlet valves 22 and the inlet valves 16 are each embodied as electrically openable and closable check valves. The inlet valve 16, in its basic position shown, is prestressed into a closing position via a spring, not shown, and can be put into an open position by the supply of current to a magnet actuator 28, so that the pressure medium can flow out of the inlet line 18 into the respective work chamber 8. The outlet valve 22, in its basic position shown, is prestressed in the open direction via a spring. By the supply of current to a magnet actuator 30, this outlet valve 22 can be put into a closed position, in which the pressure fluid cannot flow out of the work chamber 8. The triggering of the magnet actuators 28, 30 is effected via a control unit 34, by way of which various modes (full mode, partial mode, idle mode) can be set, so that the absorption volume of the piston engine 1 is continuously variably adjustable, and by suitable triggering of the valves 16, 22, the pulsation can be reduced to a minimum as well. In the exemplary embodiment shown, the triggering of the valves 16, 22 is effected as a function of the rpm of the power takeoff shaft 12, which is detected via an rpm pickup 36 and reported to the overall control unit 34 via a signal line. In principle, it is understood that still other characteristic data, such as the torque acting on the power takeoff shaft 12, the absorption volume of the piston engine 1, or the angle of rotation of the swash plate, can be taken into account in the triggering of the valves 16, 22.

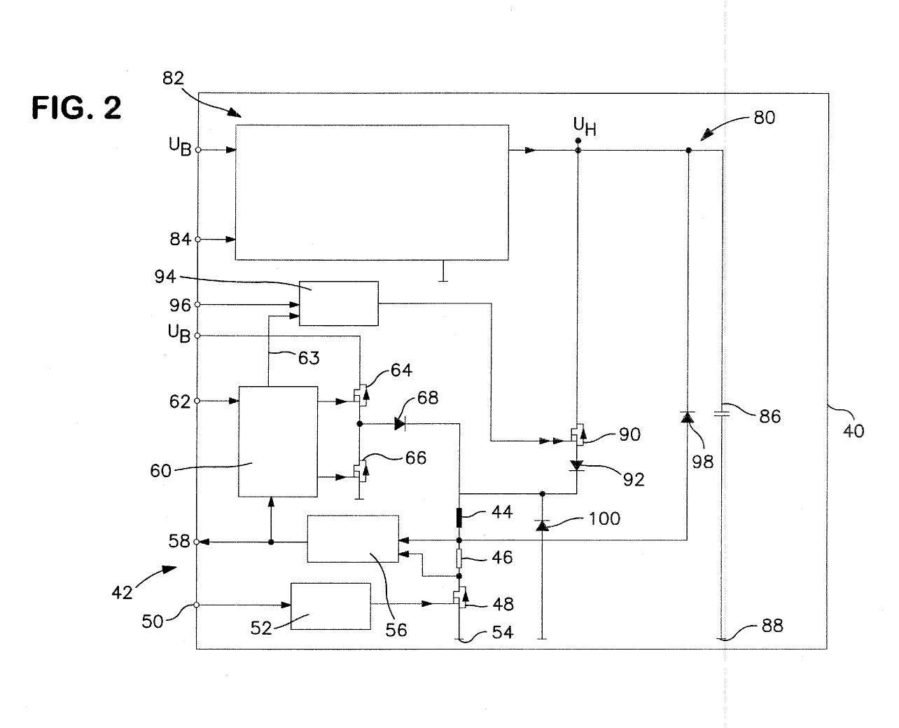

FIG. 2 shows the basic construction of a control unit 40. This control unit 40 includes, among other elements, a current regulating device 42 for regulating the current of a coil 44 of a solenoid valve, not shown in further detail.

The coil 44 is connected to ground 54, on its end toward ground, via a measuring resistor 46 and a field effect transistor 48, which transistor is switched on and off by means of an external trigger signal 50, via a gate trigger circuit 52. A differential amplifier 56 detects the voltage drop applied via the measuring resistor 46 and delivers the corresponding measured value, which is additionally conducted to the outside as a signal 58, to a regulating amplifier 60. This amplifier, taking into account an external set-point value signal 62, triggers two field effect transistors 64 and 66 in such a way that the voltage, supplied via a diode 68 to the supply-voltage-side end of the coil 44, corresponds to the desired set-point value.

The field effect transistors 64 and 66 are triggered in pulse width modulated fashion by the regulating amplifier 60, so that the coil 44 either is connected via the field effect transistor 64 to the supply voltage or, via the field effect transistor 66, contacts the ground terminal 54.

FIG. 2 also shows a voltage-increasing device 80. The voltage-increasing device 80 has a boosting circuit 82, which on the input side receives an external set-point value signal 84, and during that time generates a higher voltage U_{H}=60 V, compared to the operating voltage U_{B}=24 V. This higher voltage serves to charge a downstream capacitor 86, which is connected to a ground terminal 88. The voltage U_{H} furnished by the capacitor 86 is dimensioned such that during the attraction phase, if a field effect transistor 90, which is connected between the capacitor 86 and the coil and which is followed by a diode 92 connected in series with it, is made conducting as a function of a gate trigger circuit 94. The gate trigger circuit 94 is triggered by an external set-point value signal 96. The coil 44 is connected on the ground side to the voltage-carrying end of the capacitor 86 via a diode 98. A freewheel diode 100 protects the field effect transistor 48 from voltage peaks upon being shut off.

In operation, the boosting circuit 82, before the attraction phase of the valve, is supplied with an external set-point value signal 84, so that the boosting circuit 82, over a period of time predetermined by the duration of the signal 84 on the input side, charges the capacitor 86 with the higher voltage U_{H}=60 V. During the attraction phase of the valve, the external set-point value signal 96 is applied to the gate trigger circuit 94, which makes the field effect transistor 90 conducting, so that the coil 44 is subjected to the voltage U_{H} applied to the capacitor 86. During this attraction phase, the capacitor 86 discharges, with a time constant which is predetermined by its capacitance. The maintenance phase of the valve begins after the termination of the triggering of the gate trigger circuit 94 and the end of the resultant blocking of the field effect transistor 90 with the external set-point value signal 62 to the regulating amplifier 60, so that during this maintenance phase, the coil is supplied with a regulated voltage via the field effect transistors 64 and 66. The regulated voltage is a clocked voltage, which alternates between operating voltage and ground potential. It results from the pulse width modulated triggering of the field effect transistors 64, 66 by the regulating amplifier 60, whose trigger signals depend on the difference between the set-point current value and the actual current value of the coil 44.

When the attraction current in the coil 44 is regulated, an output signal 63 of the regulating amplifier 60 leads to the gate trigger circuit 94, so that the field effect transistor 90 is triggered, as a function of the actual current of the coil 44 and of the set-point value from set-point value signal 62. As a result, excessively high currents are avoided during the attraction phase.

For the invention, a clocked trigger voltage is not compulsory for the current-regulated triggering of the actuators. To accomplish the fastest possible buildup of the magnetic field, the trigger voltage can be switched on or off in unclocked fashion accordingly in the attraction phase or at the end of the maintenance phase.

The foregoing relates to a preferred exemplary embodiment of the invention, it being understood that other variants and embodiments thereof are possible within the spirit and scope of the invention, the latter being defined by the appended claims.

1. A hydraulic system, having
a hydrostatic, valve-controlled piston engine with a plurality of valves actuatable by means of an actuator as a function of motions of a plurality of pistons, and with
a control unit for triggering the actuators, which is arranged for generating an electrical attraction current in a first time segment and a maintenance current in a second time segment, wherein the control unit includes a current regulating device, which triggers the actuators by a current-regulated triggering.

2. The hydraulic system as defined by claim 1, wherein the current-regulated triggering of the actuator is effected in the first time segment and/or in the second time segment.

3. The hydraulic system as defined by claim 1, wherein the current-regulated triggering of the actuator is effected by means of a clocked trigger voltage output by the control unit.

4. The hydraulic system as defined by claim 2, wherein the current-regulated triggering of the actuator is effected by means of a clocked trigger voltage output by the control unit.

5. The hydraulic system as defined by claim 1, wherein the current regulating device, for measuring an actuator current, has a measuring resistor connected downstream of the actuator.

6. The hydraulic system as defined by claim 4, wherein the current regulating device, for measuring an actuator current, has a measuring resistor connected downstream of the actuator.

7. The hydraulic system as defined by claim 5, wherein the current regulating device includes a differential amplifier, which detects a voltage drop applied via the measuring resistor.

8. The hydraulic system as defined by claim 6, wherein the current regulating device includes a differential amplifier, which detects a voltage drop applied via the measuring resistor.

9. The hydraulic system as defined by claim 7, wherein the current regulating device includes a regulating amplifier, connected downstream of the differential amplifier, which regulating amplifier compares an output signal of the differential amplifier, as an actual current value, with a set-point current value.

10. The hydraulic system as defined by claim 8, wherein the current regulating device includes a regulating amplifier, connected downstream of the differential amplifier, which regulating amplifier compares an output signal of the differential amplifier, as an actual current value, with a set-point current value.

11. The hydraulic system as defined by claim 1, wherein the current regulating device has first switching elements and a pulse width modulator for triggering the first switching elements.

12. The hydraulic system as defined by claim 10, wherein the current regulating device has first switching elements and a pulse width modulator for triggering the first switching elements.

13. The hydraulic system as defined by claim 11, wherein the first switching elements are field effect transistors.

14. The hydraulic system as defined by claim 1, wherein the current regulating device is implemented as an integrated circuit.

15. The hydraulic system as defined by claim 1, wherein communication within the control unit is effected via a bus system.

16. The hydraulic system as defined by claim 1, wherein the control unit has a voltage-increasing device, which from an operating voltage of the control unit generates a higher voltage.

17. The hydraulic system as defined by claim 1, wherein the voltage-increasing device has a boosting circuit, which in response to a corresponding trigger signal charges a buffer memory to a higher voltage.

18. The hydraulic system as defined by claim 1, wherein the buffer memory, during the first time segment, is switched to the actuator by a second switching element.

19. The hydraulic system as defined by claim 1, wherein the current regulating device, for regulating current of the actuator, triggers the second switching element during the first time segment.

20. The hydraulic system as defined by claim 1, wherein the current regulating device, for regulating current of the actuator, triggers the first switching elements during the second time segment.
